(19) United States
(12) Patent Application Publication
(10) Pub. No.: US 2019/0050845 A1
(43) Pub. Date: Feb. 14, 2019

(54) SYSTEM AND METHOD FOR BILL PAYMENT THROUGH MESSAGE ON A MOBILE COMMUNICATION DEVICE

(71) Applicant: OSLABB PTE. LTD., Singapore (SG)

(72) Inventors: RAKESH DESHMUKH, Indore (IN); SUDHIR BANGARAMBANDI, Mumbai (IN)

(21) Appl. No.: 16/076,313

(22) PCT Filed: Feb. 7, 2017
(86) PCT No.: PCT/IB2017/050641

§ 371 Date: Aug. 7, 2018

(30) Foreign Application Priority Data
Feb. 8, 2016 (SG) 10201600952P

(51) Int. Cl. G06Q 20/32; G06Q 20/10; G06Q 20/36

(52) U.S. Cl. CPC G06Q 20/3255; G06Q 20/3223; G06Q 20/3672; G06Q 20/102

(57) ABSTRACT

The embodiments herein provides a system and method for enabling a user to make bill payment through bill notification SMS received by the user. In one embodiment, the smart bill payment is enabled on a mobile communication device of the user by a smart bill payment application installed in the mobile communication device. In another embodiment, a feature embedded in the operating system of the mobile communication device enables the smart bill payment. The system identifies a bill payment SMS received on the mobile communication device and prompts the user to initiate payment through the bill payment SMS. Once the user initiates the payment, the user is directed to a bill payment application displaying the payment page with a preferred mode of payment and details of payment being prefilled. The user is enabled to make payment by clicking submit button to complete the payment.

### CROSS-REFERENCE TO RELATED APPLICATION

This patent application is a National Phase Application corresponding to the PCT Application No. PCT/IB2017/050641 filed on Feb. 7, 2017 with the title “SYSTEM AND METHOD FOR BILL PAYMENT THROUGH MESSAGE ON A MOBILE COMMUNICATION DEVICE”. This patent application claims the priority of the Singapore Provisional Patent Application No. 10201600952P filed on Feb. 8, 2016 with the title “SYSTEM AND METHOD TO INITIATE BILL PAYMENT THROUGH PUSH NOTIFICATIONS RECEIVED ON A COMPUTING DEVICE”, the contents of which is included herein by the way of reference.

### BACKGROUND

### Technical Field

The embodiments herein are generally related to e-commerce payment system. The embodiments herein are particularly related to facilitating payment via internet on a mobile communication device. The embodiments herein is more particularly related to enabling payment of bills received through bill payment notifications as message on a mobile communication device

### Description of the Related Art

Tracking and payment of multiple bills has always been a cumbersome job. With the advancement in e-commerce technology, safe and secure payment methods via internet are available currently. People are enabled to initiate payments and financial transactions using electronic devices through internet. The payment transactions include, for example, purchasing goods and/or services, bill payments, and transferring funds between bank accounts etc. However, the process of remembering all the bills to be paid and making the bill payments within the due date is again a laborious process.

Currently, the notifications for most of the bills are received as both emails as well as short message services. However, most of the people just see and forget the SMS notifications received on the mobile communication devices. In order to make payment, the user needs to login to the particular websites and initiate a payment. However, there are no existing methods enabling a user to make an online bill payment directly from a notification received.

Hence, there is a need for an efficient system and method to enable a user to make a bill payment directly from the bill payment notification. There is also a need to set reminders for bill payment directly from the bill payment notification. Further, there is a need to enable the user to make bill payment with minimum effort.

The above-mentioned shortcomings, disadvantages and problems are addressed herein, which will be understood by reading and studying the following specification.

### OBJECTS OF THE EMBODIMENTS HEREIN

The primary object of the embodiments herein are to provide a method and system for bill payment that enables a user to pay bills directly from bill payment notifications.

Another object of the embodiments herein are to provide a method and system for enabling bill payment using a smart bill payment application installed on a handheld communication device.

Yet another object of the embodiments herein are to provide a method and system for enabling bill payment with a feature embedded on the operating system of a handheld communication device.

Yet another object of the embodiments herein are to provide a method and system for bill payment that prompts a user to initiate the payment on receiving a bill payment SMS, thereby avoiding the need for memorizing the bills to be paid.

Yet another object of the embodiments herein are to provide a method and system for bill payment configured to direct a user to a bill payment application prefilled with the required details on initiating a payment through the bill payment SMS, thereby reducing the efforts of the user.

Yet another object of the embodiments herein are to provide a method and system for bill payment that enables a user to automatically set a reminder on a task scheduler for bill payment upon receiving a bill payment SMS.

Yet another object of the embodiments herein are to provide a method and system for enabling a user to recharge an e-wallet when the amount or money in the e-wallet is less than the amount of money required to make a payment transaction based on a bill payment SMS.

Yet another object of the embodiments herein are to provide a smart recharge application on the mobile communication device that enables a user to recharge a pre-paid mobile phone account with minimum effort.

These and other objects and advantages of the embodiments herein will become readily apparent from the following detailed description taken in conjunction with the accompanying drawings.

### SUMMARY

The various embodiments herein provide a method and system for enabling a user to make bill payment through a bill notification received by the user. In one embodiment, the bill payment is enabled on a mobile communication device of the user through a bill payment application installed in the mobile communication device. In another embodiment, a feature embedded in the operating system of the mobile communication device enables the bill payment. The system identifies a bill payment SMS received on the mobile communication device and prompts the user to initiate payment through the bill payment SMS. Once the user initiates the payment, the user is directed to a bill payment application displaying the payment page with a preferred mode of payment and details of payment being prefilled. The user is enabled to make payment by authorizing and validating the payment.

According to an embodiments herein, method and system for bill payment is provided. The system comprises an SMS identification module, a SMS inbox, an e-commerce module, an e-wallet and a scheduler module. The SMS identification module interacts with the SMS inbox to check each SMS received on a mobile communication device and distinguishes a bill payment SMS from other SMS messages. On identifying the bill payment SMS, the SMS identification module embeds the bill payment SMS with a prompt to enable the user to initiate the payment of the bill. The user is enabled to either initiate the payment or schedule a reminder to be prompted for paying the bill later. The scheduler module also extracts and stores the payment information to initiate a payment later.

Once a user initiates the payment, the SMS identification module interacts with the e-commerce module to initiate and complete the payment transaction. The SMS identification module extracts the payment information from the bill payment SMS received. The payment information comprises vendor details, bill amount, etc. The e-commerce module interacts with an e-wallet module to initiate the payment. The user is provided with a payment page with the preferred payment mode from the e-wallet module. Once the user chooses the preferred mode of payment, the e-commerce module automatically fills the payment page with the payment information extracted by the SMS identification module. The user makes payment by authorizing and validating on the payment page to complete the payment.

According to an embodiments herein, a method for bill payment is provided. The method includes receiving a SMS bill notification by a user on a mobile communication device. Each SMS received on the user's mobile communication device is analyzed and the system distinguishes a bill payment SMS from other SMS messages. Once a bill payment message is identified, the user is prompted to initiate a bill payment through the bill payment SMS. Further, the user is also enabled to set a reminder, through the bill payment SMS, to make the payment later. Once the user initiates a bill payment, the user is directed to a payment page to make payment through a preferred payment option. Further, the payment page is provided with all the details automatically filled from the details extracted from the bill payment SMS and information stored on the database. The user is enabled to check the information, authorize and validate the payment to complete the payment transaction.

According to an embodiments herein, a method for recharging a pre-paid mobile phone account on the mobile communication device is provided. The method includes providing the user with a prompt to recharge the pre-paid mobile phone account on the notification received by the user from the mobile service provided. The user is provided with the information of the current balance on the pre-paid mobile account. Once the user initiates the recharge, a recharge application is invoked. Further, the user's mobile phone number and preferred recharge amount is identified by the recharge application. The recharge application directs the user to a payment page, where the phone number and the recharge amount are automatically filled. The user initiates payment through the payment mode supported by the recharge application and completes the payment by authorizing and validating the transaction.

According to an embodiments herein, users are enabled to integrate user-preferred information such as history of recharging mobile phone account payments. A plurality of payment methods such as credit cards, debit cards, netbanking, e-wallets etc. are also integrated in the present embodiment.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for enabling bill payment through a mobile communication device, in accordance with one embodiments herein.

FIG. 2 illustrates a flowchart of a method for enabling a user to perform bill payment through a mobile communication device, in accordance with one embodiments herein.

FIG. 3 illustrates a flowchart of a method for enabling a user to perform recharge of a pre-paid mobile phone account, in accordance with one embodiments herein.

FIG. 4 illustrates an exemplary implementation of the embodiments herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a method and system for enabling a user to make bill payment through a bill notification SMS received by the user. In one embodiment, the bill payment is enabled on a mobile communication device of the user through a bill payment application installed in the mobile communication device. In another embodiment, a feature embedded in the operating system of the mobile communication device enables the bill payment. The system identifies a bill payment SMS received on the mobile communication device and prompts the user to initiate payment through the bill payment SMS. Once the user initiates the payment, the user is directed to a bill payment application displaying the payment page with a preferred mode of payment and details of payment being prefilled. The user is enabled to make payment by authorizing and validating the payment.

According to an embodiments herein, a system for bill payment that enables a user to pay bills directly from bill payment notifications received as message on a mobile computing device. Further, the system comprises a hardware processor 120; a memory 130 adapted to store processor-executable instructions, an SMS identification module 102, an SMS inbox 104, and E-commerce module 106, and E-wallet module 108 and a Scheduler module 110. Further, the SMS inbox 104 receive messages on a mobile communication device. Furthermore, the SMS identification module 102 is adapted to interact with the SMS inbox to check and compare each message in the SMS inbox with a set of templates in order to identify the incoming SMS as bill payment message, the SMS identification module 102 upon identification of the incoming message as bill payment notification, provides “pay now” and “remind later” icon on the SMS screen to prompt the user to pay the bill from SMS screen and extracts the payment information from the bill payment message. Moreover, the E-commerce module 106 is adapted to initiate payment of the bill when the user select option of pay now on the SMS screen, which further displays a payment page through the bill payment application on the mobile communication device wherein the details on the payment page is automatically filled from the payment details extracted by the SMS identification module 102 from the bill payment notification SMS. Further, the E-wallet module 108 is adapted to make payment through preferred mode of payment selected by the user from supported mode of payment on the mobile communication device, wherein the E-wallet module displays available balance in preferred mode of payment, and if balance is low, initiate a recharge application, and make the payment by preferred mode of payment. Additionally, the scheduler module is adapted to schedule the payment at user selected time and date by interacting with a calendar application in the mobile communication device, when the user selects the remind later icon on the SMS screen and prompt the user to make the payment on the scheduled date and time by providing notification message on SMS screen, wherein the user may select “pay now” or “remind later” option again.

According to an embodiments herein, the SMS identification module 102 is further adapted to add message as template when the user identify an SMS as a bill payment message. Additionally, the E-commerce module 106 includes a smart bill payment module adapted to provide option to the user to select the preferred mode of payment from available mode of payment supported by the mobile communication device and displays the available balance in the preferred mode of payment and intelligent notification to increase the available balance in the preferred mode of payment.

According to an embodiments herein, a method for bill payment that enables a user to pay bills directly from bill payment notifications received as message on a mobile computing device, wherein the method comprising steps of: receiving messages on a mobile communication device by an SMS inbox; checking and comparing each messages in the SMS inbox with a set of templates in order to identify the incoming SMS as bill payment message by an SMS identification module, wherein the SMS identification module, upon identification of the incoming message as bill payment notification configured to provide “pay now” and “remind later” icon on the SMS screen to prompt the user to pay the bill from SMS screen and extracts the payment information from the bill payment message; initiating payment of the bill when the user select option of pay now on the SMS screen by an E-commerce module, which further configured to display a payment page through the bill payment application on the mobile communication device wherein the details on the payment page is automatically filled from the payment details extracted by the SMS identification module from the bill payment notification SMS; making payment through preferred mode of payment selected by the user from supported mode of payment on the mobile communication device by an E-wallet module, wherein the E-wallet module configured to display available balance in preferred mode of payment, and if balance is low, initiate a recharge application, and make the payment by preferred mode of payment; and scheduling the payment at a different time and date by a scheduler module by interacting with a calendar application in the mobile communication device, when the user selects the remind later icon on the SMS screen and prompt the user to make the payment on the scheduled date and time by providing notification message on SMS screen, wherein the user may select “pay now” or “remind later” option again. Further, the SMS identification module is configured to add message as template when the user identify an SMS as a bill payment message. Moreover, the E-commerce module includes a smart bill payment module configured to provide option to the user to select the preferred mode of payment from available mode of payment supported by the mobile communication device and displays the available balance in the preferred mode of payment and intelligent notification to recharge.

According to one embodiment of the invention, a non-transitory computer readable medium having computer readable instructions stored thereupon is disclosed, said computer readable instructions, when executed by a processor, to configure a computer enabled device to: receive messages on a mobile communication device by an SMS inbox; check and compare each messages in the SMS inbox with a set of templates in order to identify the incoming SMS as bill payment message by an SMS identification module, wherein the SMS identification module, upon identification of the incoming message as bill payment notification configured to provide “pay now” and “remind later” icon on the SMS screen to prompt the user to pay the bill from SMS screen and extracts the payment information from the bill payment message; initiate payment of the bill when the user select option of pay now on the SMS screen by an E-commerce module, which further configured to display a payment page through the bill payment application on the mobile communication device wherein the details on the payment page is automatically filled from the payment details extracted by the SMS identification module from the bill payment notification SMS; make payment through preferred mode of payment selected by the user from supported mode of payment on the mobile communication device by an E-wallet module, wherein the E-wallet module configured to display available balance in preferred mode of payment, and if balance is low, initiate a recharge application, and make the payment by preferred mode of payment; schedule the payment at a different time and date by a scheduler module by interacting with a calendar application in the mobile communication device, when the user selects the remind later icon on the SMS screen and prompt the user to make the payment on the scheduled date and time by providing notification message on SMS screen, wherein the user may select “pay now” or “remind later” option again. Further, the SMS identification module is further configured to add message as template when the user identify an SMS as a bill payment message. Moreover, the E-commerce module includes a smart bill payment module configured to provide option to the user to select the preferred mode of payment from available mode of payment supported by the mobile communication device and displays the available balance in the preferred mode of payment and intelligent notification to recharge.

According to an embodiments herein, method and system for bill payment is provided. The system comprises an SMS identification module, a SMS inbox, an e-commerce module, an e-wallet and a scheduler module. The SMS identification module interacts with the SMS inbox to check each SMS received on a mobile communication device and distinguishes a bill payment SMS from other SMS messages. On identifying the bill payment SMS, the SMS identification module embeds the bill payment SMS with a prompt to enable the user to initiate the payment of the bill. The user is enabled to either initiate the payment or schedule a reminder to be prompted for paying the bill later. The scheduler module also extracts and stores the payment information to initiate a payment later.

Once a user initiates the payment, the SMS identification module interacts with the e-commerce module to initiate and complete the payment transaction. The SMS identification module extracts the payment information from the bill payment SMS received. The payment information comprises vendor details, bill amount, etc. The e-commerce module interacts with an e-wallet module to initiate the payment. The user is provided with a payment page with the preferred payment mode from the e-wallet module. Once the user chooses the preferred mode of payment, the e-commerce module automatically fills the payment page with the payment information extracted by the SMS identification module. The user makes payment by authorizing and validating on the payment page to complete the payment.

According to an embodiments herein, a method for bill payment is provided. The method includes receiving a SMS bill notification by a user on a mobile communication device. Each SMS received on the user's mobile communication device is analyzed and the system distinguishes a bill payment SMS from other SMS messages. Once a bill payment message is identified, the user is prompted to initiate a bill payment through the bill payment SMS. Further, the user is also enabled to set a reminder, through the bill payment SMS, to make the payment later. Once the user initiates a bill payment, the user is directed to a payment page to make payment through a preferred payment option. Further, the payment page is provided with all the details automatically filled from the details extracted from the bill payment SMS and information stored on the database. The user is enabled to check the information, authorize and validate the payment to complete the payment transaction.

According to an embodiments herein, a method for recharging a pre-paid mobile phone account on the mobile communication device is provided. The method includes providing the user with a prompt to recharge the pre-paid mobile phone account on the notification received by the user from the mobile service provided. The user is provided with the information of the current balance on the pre-paid mobile account. Once the user initiates the recharge, a recharge application is invoked. Further, the user's mobile phone number and preferred recharge amount is identified by the recharge application. The recharge application directs the user to a payment page, where the phone number and the recharge amount are automatically filled. The user initiates payment through the payment mode supported by the recharge application and completes the payment by authorizing and validating the transaction.

According to an embodiments herein, users are enabled to integrate user-preferred information such as history of recharging mobile phone account payments. A plurality of payment methods such as credit cards, debit cards, netbanking, e-wallets, Unified Payment Interface (UPI) etc. are also integrated in the present embodiment.

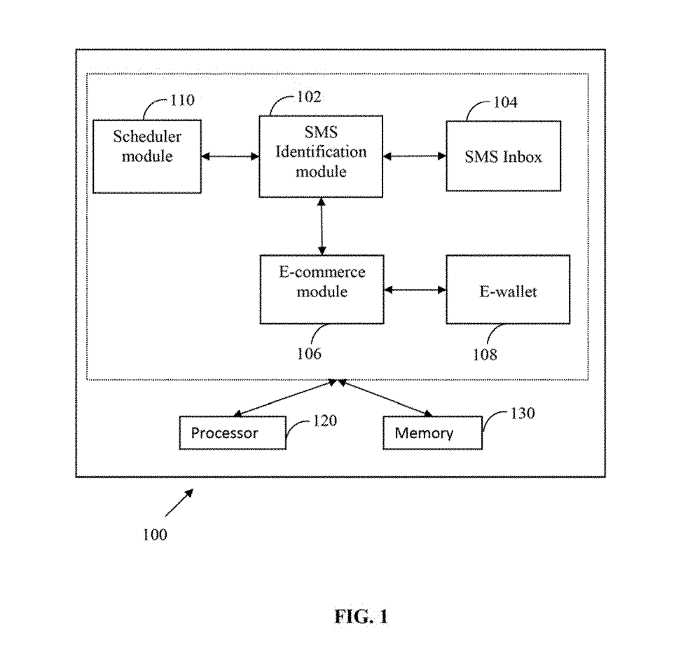

FIG. 1 illustrates block diagram of a system for a system for enabling smart bill payment via a mobile communication device. The mobile communication device includes but is not limited to a smart phone, a mobile phone, a personal digital assistant, a tablet, etc. The system for smart bill payment comprises a SMS identification module 102, a SMS inbox 104, an E-commerce module 106, an E-wallet module 108 and a scheduler module 110. The SMS inbox 104 receives all the SMS received by the mobile communication module. The SMS identification module 102 interacts with the SMS inbox 104 and checks each SMS in the SMS inbox 104. The SMS identification module 106 compares each message in the SMS inbox 104 with a set of templates. Further, an algorithm in the SMS identification module 102 is capable of parsing the incoming SMS to identify the bill payment messages. Further, the system enables the user to identify an SMS as a bill payment SMS, which is further, added to the set of templates. The SMS identification module 102 further extracts the payment information from the bill payment messages.

Further, the user is prompted to initiate the bill payment through the bill payment SMS. The user is also enabled to select a ‘remind me later’ option through the bill payment SMS. Once the user selects a ‘remind me later’ option, the scheduler module 110 schedules the payment at a different time by interacting with a calendar application in the mobile communication device. Further, the scheduler module 110 stores the payment information extracted by the SMS identification module 102.

Once the user initiates the bill payment, the system opens a smart bill payment application installed on the mobile communication device with preselected payment options. The SMS identification module 102 interacts with the E-commerce module 106 and displays a payment page through the bill payment application on the mobile communication device. The E-commerce module 106 automatically fills the details on the payment page for the payment details extracted from the bill payment SMS. Further, the user is provided with a preferred mode of payment through the E-wallet 108. The user is enabled to click on a submit button for completing the payment. In one embodiment of the invention, the system is also embedded in to the operating system of the mobile communication device.

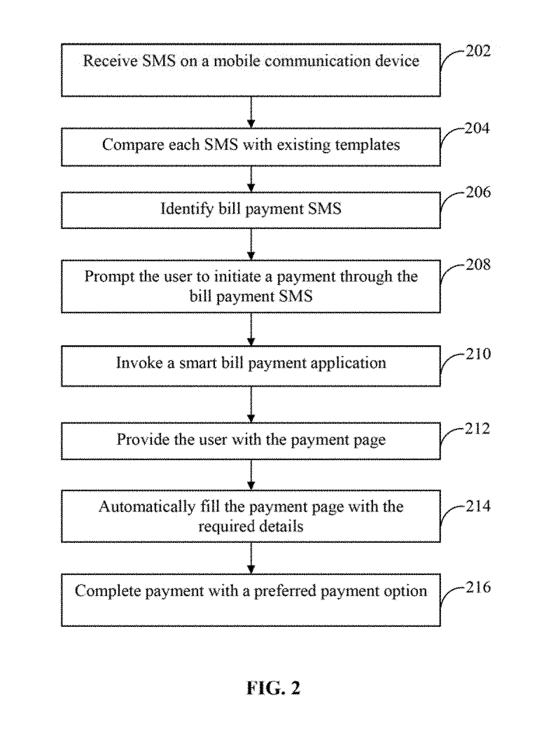

FIG. 2 illustrates a flowchart of a method for enabling a user to perform smart bill payment via a mobile communication device. The method includes receiving SMS on a mobile communication device (202). Each of the SMS received on the mobile communication device is compared with a set of existing template (204). The set of templates are stored in a template repository. The comparison is performed based on keyword based semantic analysis to identify if the SMS is likely to be a bill payment SMS. If the message is not identified as a bill payment SMS, then the user is provided with a menu to mark the SMS as a normal SMS or a bill payment SMS. The SMS marked by the user as bill payment SMS is further added to the set of templates and is stored in the template repository. Thus, the bill payment SMS are identified (206). Further, the payment information including biller name and amount are extracted from the bill payment SMS.

Once a bill payment SMS is identified, the user is prompted to initiate a payment through the bill payment SMS (208). On initiating the payment a smart bill payment application is invoked (210). Further, the payment information is passed to the smart bill payment application. The smart bill payment application opens a payment page based on the preference of the user (212). The payment page is automatically filled with the required details (214). The user is enabled to press the submit button on the payment page to complete the payment (216).

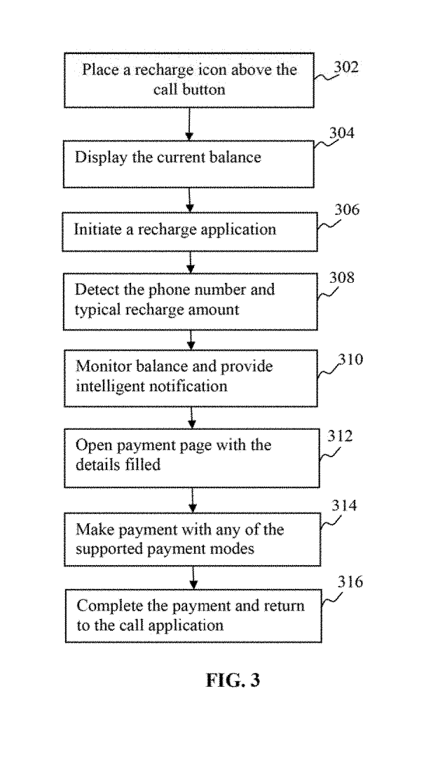

FIG. 3 illustrates a flowchart of a method for enabling a user to perform smart recharge via a mobile communication device. The method enables the user to recharge the mobile communication device with ease. The method includes placing a recharge icon at the top of a call button on the mobile communication device (302). The recharge icon displays the current balance available in the mobile communication device (304). The user is enabled to click on the icon to initiate the recharge application if the available balance is low (306). The recharge application detects the phone number of the mobile communication device and the typical recharge amount or package that the user generally uses for recharging (308).

Further, the recharge application is capable of monitoring the balance to provide the user an intelligent notification in case the balance is less that a particular amount (310). The balance is monitored to detect/learn the recharge points of the user. The recharge point is the detected by listing down all the available recharges of the user and grouping the recharges into clusters based on recharge amount. Once grouped, the largest cluster(s) are identified and average value is calculated to identify the recharge point. Further, the user is enabled to provide to set the threshold for balance. Therefore, the recharge application provides notification when the balance falls below the threshold set by the user.

Once the user clicks on the recharge icon, the user is directed to a payment page on the recharge application. The payment page is automatically filled with the phone number and the recharge amount (312). The user is enabled to make the payment with any of the payment mode supported by the recharge application (314). The user clicks on the submit button on the payment page to complete the payment. On successful completion of the recharge, the user is returned to the call application (316).

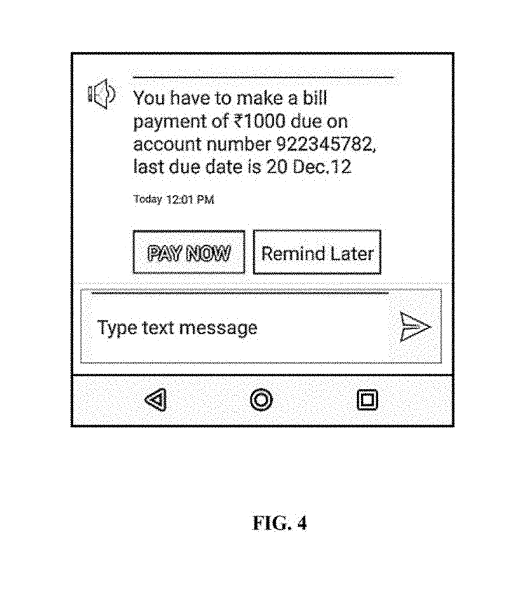

FIG. 4 illustrates an exemplary implementation of the embodiments herein.

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of an illustration and not of a limitation. Many changes and modifications may be made within the scope of the embodiments herein without departing from the spirit thereof, and the embodiments herein include all such modifications.

The embodiments herein provides provide a method and system for enabling a user to make bill payment through a bill notification SMS received by the user. The system enables the bill payment through a smart bill payment application installed in a handheld communication device or a feature embedded in the operating system of the communication device. The system enables a user to pay the bills as soon as receiving a bill payment SMS. The bill payment is made directly from the bill payment SMS. Therefore, the user does not have to keep memorizing the bills to be paid. Further, in case of shortage of money, the user is enabled to set a reminder date directly from the bill payment SMS.

Further, the payment page is prefilled with all the payment information from the bill payment SMS, thereby reducing the time required to make a payment. The bill payment SMS may also be embedded with a feature to recharge the wallet if the required amount is not available in the account. Further, the user is enabled to easily recharge the mobile communication device by clicking on a recharge icon. The payment page is provided with details including phone number and recharge amount. The user is also provided with intelligent notification regarding the recharge. The system therefore enables the user to pay the bills and recharge with little effort.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modifications.

Although the embodiments herein are described with various specific embodiments, it will be obvious for a person skilled in the art to practice the embodiments herein with modifications.

What is claimed is:

1. A system for bill payment that enables a user to pay bills directly from bill payment notifications received as message on a mobile computing device, the system comprising:
a hardware processor;
a memory adapted to store processor-executable instructions;
an SMS inbox Receive to receive messages on a mobile communication device;
an SMS identification module adapted to interact with the SMS inbox to identify the incoming message as bill payment message, and to provide “pay now” and “remind later” option on the SMS screen to prompt the user to pay the bill from SMS screen and extracts the payment information from the bill payment message;
an E-commerce module adapted to initiate payment of the bill when the user select option of pay now on the SMS screen, and to display a payment page on the mobile communication device wherein the details on the payment page is automatically filled from the payment details extracted by the SMS identification module from the bill payment message;
an E-wallet module adapted to make payment through preferred mode of payment selected by the user from supported mode of payment on the mobile communication device, wherein the E-wallet module displays available balance in preferred mode of payment, and if balance is low, initiate a recharge application, and make the payment by preferred mode of payment; and
a scheduler module adapted to schedule the payment at a different time and date, if the user selects the remind later icon on the SMS screen and prompt the user to make the payment on the scheduled date and time by providing notification message on SMS screen, wherein the user may select “pay now” or “remind later” option again.

2. The system as claimed in claim 1, wherein the SMS identification module has preloaded template of bill payment notification and also adapted to add message as bill payment notification template when the user identify a message as a bill payment message.

3. The system as claimed in claim 1, wherein the E-commerce module includes a smart bill payment module adapted to provide option to the user to select the preferred mode of payment from available mode of payment supported by the mobile communication device and displays the available balance in the preferred mode of payment and intelligent notification to recharge.

4. A method for bill payment that enables a user to pay bills directly from bill payment notifications received as message on a mobile computing device, wherein the method comprising steps of:
receiving messages on a mobile communication device by an SMS inbox;
identifying the incoming message as bill payment message by an SMS identification module, wherein the SMS identification module is configured to provide “pay now” and “remind later” icon on an SMS screen to prompt the user to pay the bill from SMS screen and extracts the payment information from the bill payment message;
initiating payment of the bill when the user select option of pay now on the SMS screen by an E-commerce module, and displaying a payment page on the mobile communication device wherein the details on the payment page is automatically filled from the payment details extracted by the SMS identification module from the bill payment message;
making payment through preferred mode of payment selected by the user from supported mode of payment on the mobile communication device by an E-wallet module, wherein the E-wallet module configured to display available balance in preferred mode of payment, and if balance is low, initiate a recharge application, and make the payment by preferred mode of payment; and
scheduling the payment at a different time and date by a scheduler module, when the user selects the remind later icon on the SMS screen and prompt the user to make the payment on the scheduled date and time by providing notification message on SMS screen, wherein the user may select “pay now” or “remind later” option again.

5. The method as claimed in claim 4, wherein the SMS identification module has preloaded template of bill payment notification and also adapted to add message as bill payment notification template when the user identify a message as a bill payment message.

6. The method as claimed in claim 5, wherein the E-commerce module includes a smart bill payment module configured to provide option to the user to select the preferred mode of payment from available mode of payment supported by the mobile communication device and displays the available balance in the preferred mode of payment and intelligent notification to recharge.

7. A non-transitory computer readable medium having computer readable instructions stored thereupon, said computer readable instructions, when executed by a processor, to configure a computer enabled device to:
receive messages on a mobile communication device by an SMS inbox;
identify the incoming message as bill payment message by an SMS identification module, wherein the SMS identification module is configured to provide “pay now” and “remind later” icon on an SMS screen to prompt the user to pay the bill from SMS screen and extracts the payment information from the bill payment message;
initiate payment of the bill when the user select option of pay now on the SMS screen by an E-commerce module, and displays a payment page on the mobile communication device wherein the details on the payment page is automatically filled from the payment details extracted by the SMS identification module from the bill payment message;
make payment through preferred mode of payment selected by the user from supported mode of payment on the mobile communication device by an E-wallet module, wherein the E-wallet module configured to display available balance in preferred mode of payment, and if balance is low, initiate a recharge application, and make the payment by preferred mode of payment,
schedule the payment at a different time and date by a scheduler module, when the user selects the remind later icon on the SMS screen and prompt the user to make the payment on the scheduled date and time by providing notification message on the SMS screen, wherein the user may select “pay now” or “remind later” option again.

8. The non-transitory computer readable medium as claimed in claim 7, wherein the SMS identification has preloaded template of bill payment notification and also adapted to add message as bill payment notification template when the user identify a message as a bill payment message.

9. The non-transitory computer readable medium as claimed in claim 7, wherein the E-commerce module includes a smart bill payment module configured to provide option to the user to select the preferred mode of payment from available mode of payment supported by the mobile communication device and displays the available balance in the preferred mode of payment and intelligent notification to recharge.
